(19) United States
(12) Patent Application Publication
(10) Pub. No.: US 2008/0069330 A1
(43) Pub. Date: Mar. 20, 2008

(54) RE-ESTABLISHING A PARKED CALL ON A SAME OR DIFFERENT DEVICE OR MEDIUM

(76) Inventors: Erik John Burckart, Raleigh, NC (US); Curtis E. Hrischuk, Holly Springs, NC (US); Matthew John Sheard, Morrisville, NC (US)

Correspondence Address: HOFFMAN WARNICK & DALESSANDRO LLC, 75 STATE ST, 14TH FLOOR, ALBANY, NY, 12207, US

(21) Appl. No.: 11/533,612

(22) Filed: Sep. 20, 2006

(51) Int. Cl. H04M 3/42

(52) U.S. Cl. 379/210.01

(57) ABSTRACT

A method for permitting re-establishment of a parked phone call on a same or different device or medium may include registering information associated with a caller to permit re-establishment of the parked phone call on the same or different communications device or medium in response to the caller electing to park the phone call. The method may also include permitting re-establishment of the parked phone call on the same or different device or medium in response to a called party becoming available.

### BACKGROUND OF THE INVENTION

The present invention relates to communications, and more particularly to a method and system for re-establishing a parked call on a same or different device or medium.

Attempting to contact certain individuals or a “live person” at a company or business by telephone can sometimes be a time consuming and extremely frustrating ordeal. A caller may be routed through a number of interactive menus. When the caller is eventually routed to the desired person or someone who may be able to assist the caller, the desired person is unavailable or the caller gets a message that all agents or representatives are busy assisting others and the caller must wait on hold for the next available agent or person. The caller may be able to leave a voice mail message or some other type of message and have the called party return the call at a later time. However, when the called party is finally available to return the call, the original caller may be unavailable via telephone but may be available via some other communications device or media which is not known to the originally called party, or the original caller may prefer that the called party re-establish the call or communication on some other device or media.

### BRIEF SUMMARY OF THE INVENTION

In accordance with an embodiment of the present invention, a method for permitting re-establishment of a parked phone call on a same or different device or medium may include registering information associated with a caller to permit re-establishment of the parked phone call on the same or different communications device or medium in response to the caller electing to park the phone call. The method may also include permitting re-establishment of the parked phone call on the same or different device or medium in response to a called party becoming available.

In accordance with another embodiment of the present invention, a system for permitting re-establishment of a parked phone call on a same or different device or medium may include a presence system to determine which device or medium to re-establish the parked phone call in response to a called party becoming available. The system may also include a register to store information associated with a caller to permit re-establishment of the parked phone call.

In accordance with another embodiment of the present invention, a computer program product for permitting re-establishment of a parked phone call on a same or different device or medium may include a computer usable medium having computer usable program code embodied therewith. The computer usable medium may include computer usable program code configured to register information associated with a caller to permit re-establishment of the parked phone call on the same or different communications device or medium in response to the caller electing to park the phone call. The computer useable medium may also include computer usable program code configured to permit re-establishment of the parked phone call on the same or different device or medium in response to a called party becoming available.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A and 1B (collectively FIG. 1) are a flow chart of an example of a method for re-establishing a parked call on a same or a different device or medium in accordance with an embodiment of the present invention.

FIG. 2 is an example of a system for re-establishing a parked call on a same or a different device or medium in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

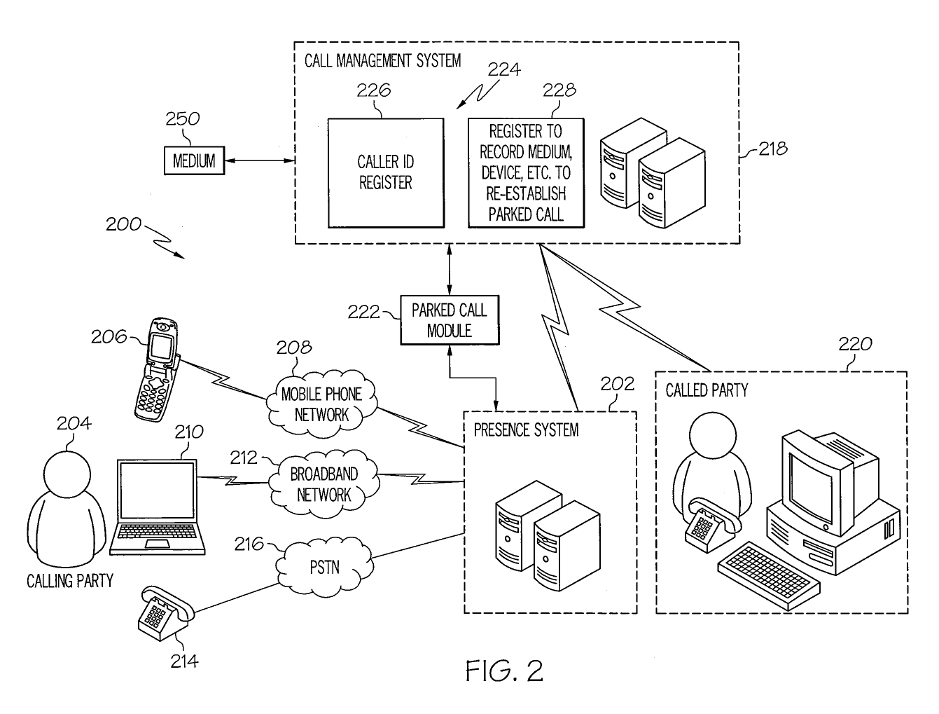

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium, for example medium 250 in FIG. 2, having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or block.

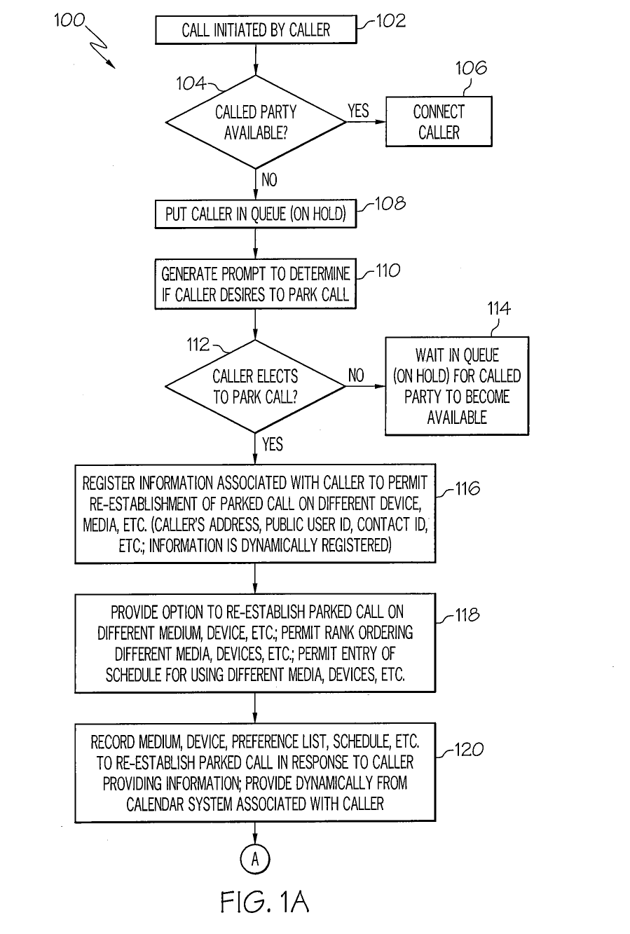

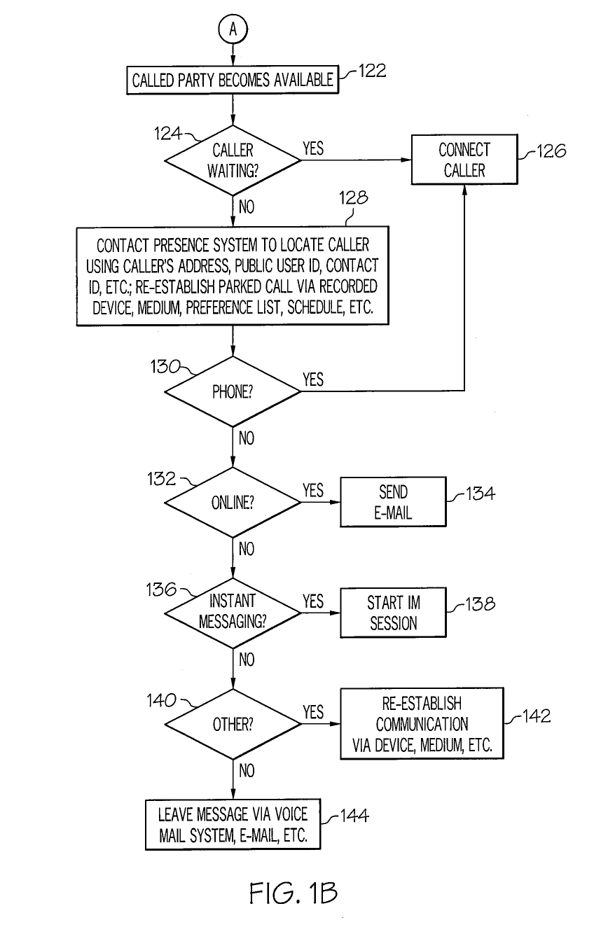

FIGS. 1A and 1B (collectively FIG. 1) are a flow chart of an example of a method 100 for re-establishing a parked call on a different device or medium in accordance with an embodiment of the present invention. A parked phone call or a feature to permit a parked call may be defined as the ability of a caller to be put into a queue in the event that a called party is unavailable. The parked call may then be re-established, as described herein, when action is possible or the called party is available or ready to take the call. The called party may be a “live” person or an interactive voice response system, call management system, or the like.

In block 102, a call may be initiated by a caller to a called party. The called party may be a particular person, a business, an interactive call system, or similar entity. In block 104, a determination may be made if the called party is available. If the called party is available, the caller may be connected to the called party in block 106. If the called party is not available or the caller's call cannot be completed for some reason, the caller may be put into a queue or on hold.

In block 110, a prompt may be generated to determine if the caller desires to park the call. The prompt may be generated by a call management system, parked call module associated with a call management system or the like similar to the call management system 218 and parked call module 222 described with reference to FIG. 2. The call management system or parked call module or feature may include a voice recognition or voice interactive feature to generate the prompt. The prompt may be a recorded or synthesized voice indicating to the caller to press or say a particular digit or simply respond with a “yes” or “no” if the caller would like to park the call for the called party to return or re-establish the call when available or ready.

In block 112, a determination may be made whether the caller elected to park the call. If the caller did not elect to park the call, the method 100 may advance to block 114. In block 114, the caller may wait in the queue or on hold for the called party, such as an agent or representative of the business to be available, or an interactive telephone or call management system to have capacity by being freed from other callers. This is similar to currently known systems when the system does not have sufficient capacity to handle call volumes at any given time and a caller must be placed on hold for a “live person” or for the system to be freed from other users or callers.

If the caller elects to park the call in block 112, the method 100 may advance to block 116. In block 116, information associated with the caller may be registered or stored to permit re-establishment of the parked call either via phone or on a different device or media. The information may include information to permit a parked call module or feature associated with a call management system to locate the caller on the different device or media. Accordingly, the information may include the caller's address, such as an e-mail address or the like, a public user identification (ID), a contact ID or similar contact or location information. In the Third Generation Partnership Project (3GPP) for communications and Internet Protocol (IP) multimedia subsystems or similar systems, users may be identifiable through a public user ID. The public user ID may be shared or also used for services beyond traditional phone services. The caller may be prompted to provide the information by using the buttons on the telephone keypad, by a voice recognition algorithm or the information may be dynamically registered. The system or the caller's equipment may be set up to automatically transfer the caller's information for re-establishing the parked call in response to electing to park the call in block 112.

In block 118, an option may be provided to re-establish the parked call on a different device, medium or the like. In another embodiment of the present invention, information related to the different device or medium to re-establish the parked call may be provided to the system or parked call module along with the caller identification information in block 116. This information may also be registered dynamically as part of the process.

The method 100 in block 118 may also permit a plurality or set of different communications devices or media to be rank ordered according to the caller's preference for re-establishment of the parked phone call. If the caller will be available for re-establishing the call on different devices or media at different times, a time schedule for using different ones of the plurality of communications devices or media may be entered, registered or stored for re-establishment of the parked call. For example, the time schedule may be dynamically entered or transmitted to the parked call module or system from a calendar system associated with the caller. The calendar system may be similar to Microsoft Outlook or similar system that may be linked to the caller's phone or communications equipment and may be transferred to the parked call module or system.

In block 120, a medium, device, preference list, time schedule or the like to re-establish the parked call may be recorded in response to the caller providing the information or the information being dynamically provided.

In block 122, the called party may become available or ready to communicate with the caller. In block 124, a determination may be made whether the caller elected not to park the call and is waiting in queue or on hold from block 114. If the caller is waiting, the method 100 may advance to block 126 and the caller may be connected.

If the caller is not waiting on hold in block 124, the method 100 may advance to block 128. In block 128, the caller may be located to re-establish the call on the same device or media or on a different device or media. A presence system may be contacted to locate the caller using the caller's address, public user ID, contact ID or similar information registered in block 116. The parked call may be re-established using the recorded or registered device, medium, preference list, time schedule or other information recorded or registered in block 120.

In block 130, a determination may be made whether the caller is available via phone or if the parked call can be re-established via phone. If so, a call may be established between the caller and the called party in block 126.

If the caller is not available via phone or the parked call can not be re-established via phone, the method 100 may advance to block 132. In block 132, a determination may be made whether the caller is online or if the parked call can be re-established via e-mail. If so, the method 100 may advance to block 134 and an e-mail may be sent to the called party to re-establish the parked call or communications.

If the caller is not available online, the method 100 may advance to block 136. In block 136, a determination may be made if the parked call can be re-established via an instant messaging session or the like. If so, an instant messaging session may be started in block 138. If not, the method 100 may advance to block 140. In block 140, a determination may be made if the caller is available via some other device or medium or if the parked call can be re-established via some other device or medium. If so, the method 100 may advance to block 142 and the parked call may be re-established via the other device or medium.

If the caller is not available via some other means or the parked call cannot be re-established by other means in block 140, the method 100 may advance to block 144. In block 144, the called party may leave a message, such as a voice mail, e-mail, instant message or the like for the caller to re-initialize the process or take some other action.

FIG. 2 is an example of a system 200 for re-establishing a parked call on a different device or medium in accordance with an embodiment of the present invention. The method 100 may embodied in or performed by the system 200. The system 200 may include a presence system 202 to determine a location of the caller or calling party 204 or to determine on which device or medium the calling party 204 may be available to re-establish the parked call. Examples of devices or media where the calling party 204 may be available to re-establish the parked call may include a wireless mobile phone 206 through a mobile phone network 208, a computing device 210 via a broadband network 212, Internet or similar network, a landline telephone via a public switched telephone network (PSTN) or other device or medium.

The presence system 202 may be contacted or accessed by a call management system 218 to determine which device or medium to use to re-establish the parked phone call in response to a called party 220 being ready or becoming available to re-establish the parked call. The call management system 218 may permit re-establishment of the parked call on the preferred device or media.

A parked call module 222 may be associated with the presence system 202, the call management system 218 or both to perform or assist in performing at least some of the functions associated with re-establishing the parked call similar to those functions described with respect to the method 100.

The system 200 may include a register 224 to store information associated with a caller to permit re-establishment of the parked phone call. The register 224 may include a caller ID register 226 or section to register or store caller address information, such as an e-mail address or the like, a public user ID, contact ID or the like. The register 224 may also include a register portion 228 or section to record a device, medium, preference list, time schedule or the like associated with each parked call and calling party 204 to re-establish the parked call. The caller ID register 226 and device/media register 228 may be separate registers or a single register.

The registers 226 and 228 are shown as being associated with the call management system 218 in FIG. 2. The registers 226 and 228 may also be associated with the presence system 202 or may be separate components similar to the parked call module 222. The parked call module 222 may also be a component of the presence system 202 or call management system 218.

A computer program product embodied in a computer useable medium 250 may include computer useable code to perform the function described herein. The computer program product and medium 250 may be similar to that previously described.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for permitting re-establishment of a parked phone call on a same or different device or medium, the method comprising:
registering information associated with a caller to permit re-establishment of the parked phone call on the same or different communications device or medium in response to the caller electing to park the phone call; and
permitting re-establishment of the parked phone call on the same or different device or medium in response to a called party becoming available.

2. The method of claim 1, further comprising providing a prompt to permit the caller to elect to park the call in response to the called party being unavailable.

3. The method of claim 1, wherein the information associated with the caller to permit re-establishment of the parked phone call on the same or different communications device or medium is dynamically registered.

4. The method of claim 1, further comprising permitting a plurality of different communications devices or media to be rank ordered according to the caller's preference for re-establishment of the parked phone call.

5. The method of claim 1, further comprising permitting entry of a time schedule for using different ones of a plurality of communications devices or media for re-establishment of the parked phone call.

6. The method of claim 5, wherein the time schedule is dynamically entered from a calendar system associated with the caller.

7. The method of claim 1, further comprising providing an option for the caller to re-establish the parked call on a selected device or medium or rank ordered preference list of a set of devices or media for re-establishing the parked call.

8. The method of claim 1, wherein re-establishing the parked phone call comprises at least one of:
determining if the caller is available via a public switched telephone network;
determining if the caller is available via a broadband network; and
determining if the caller is available via a mobile communications network.

9. The method of claim 1, wherein re-establishing the parked phone call comprises one of:
establishing a phone call between the caller and the called party;
sending an e-mail; and
starting an instant message session.

10. A system for permitting re-establishment of a parked phone call on a same or different device or medium, the system comprising:
a presence system to determine which device or medium to re-establish the parked phone call in response to a called party becoming a available; and
a register to store information associated with a caller to permit re-establishment of the parked phone call.

11. The system of claim 10, further comprising a call management system to permit re-establishment of the parked call on a preferred device or media.

12. The system of claim 10, wherein the call management system is adapted to contact the presence system to locate the caller using identification information associated with the caller.

13. The system of claim 10, further comprising a storage device to store one of a rank ordered preference list of devices and media for re-establishing the parked phone call and a time schedule for using different devices or media.

14. The system of claim 10, wherein the presence system is adapted to re-establish the parked call by:
establishing a phone call between the caller and the called party in response to the caller and called party being available by phone;
sending an e-mail in response to the caller being online; and
sending an instant message to start an instant message session in response to the caller currently using an instant messaging system when the parked phone call is re-established on the same or different device or media.

15. A computer program product for permitting re-establishment of a parked phone call on a same or different device or medium, the computer program product comprising:
a computer usable medium having computer usable program code embodied therewith, the computer usable medium comprising:
computer usable program code configured to register information associated with a caller to permit re-establishment of the parked phone call on the same or different communications device or medium in response to the caller electing to park the phone call; and
computer usable program code configured to permit re-establishment of the parked phone call on the same or different device or medium in response to a called party becoming available.

16. The computer program product of claim 15, further comprising computer usable program code configured to provide a prompt to permit the caller to elect to park the call in response to the called party being unavailable.

17. The computer program product of claim 15, further comprising computer usable program code configured to permit a plurality of different communications devices or media to be rank ordered according to a caller's preference for re-establishment of the parked phone call.

18. The computer program product of claim 15, further comprising:
computer usable program code configured to determine if the caller is available via a public switched telephone network;
computer usable program code configured to determine if the caller is available via a broadband network; and
computer usable program code configured to determine if the caller is available via a mobile communications network.

19. The computer program product of claim 15, further comprising computer usable program code configured to re-establish the parked call in response to one of a selected device or medium, a rank ordered preference list of a set of devices or media, and a time schedule for using different ones of a plurality of communications devices or media for re-establishment of the parked phone call.

20. The computer program product of claim 15, further comprising computer usable program code configured to re-establish the parked phone call by one of: establishing a phone call between the caller and the called party; sending an e-mail; and starting an instant message session.
